(19) United States
(12) Patent Application Publication
(10) Pub. No.: US 2023/0089163 A1
(43) Pub. Date: Mar. 23, 2023

(54) A device for heating a room using underfloor heating

(71) Applicant: OGS SEED AS, Oslo (NO)

(72) Inventor: Ole Gunnar Selvaag, Oslo (NO)

(21) Appl. No.: 17/754,811

(22) PCT Filed: Nov. 5, 2020
(86) PCT No.: PCT/NO2020/050271

§ 371 Date: Apr. 21, 2022

(30) Foreign Application Priority Data
Nov. 5, 2019 (NO) 20191320

(51) Int. Cl. F24D 3/14; F24D 5/04; E04B 5/48

(52) U.S. Cl. CPC F24D 3/145; F24D 5/04; E04B 5/48; F24D 3/18

(57) ABSTRACT

A device for heating a room (2) in a building by means of underfloor heating, the floor comprising pipe loops (4) for circulation of a hot medium, preferably water. The floor has a subfloor (1) and an upper floor (8) at a mutual distance, so that an air-filled chamber (16) is formed between them. In the outer wall (3) of the room there are inlet openings (7) for fresh air, which by means of negative pressure ventilation in the room (2) flows into the chamber (16), over the pipe loops (4) to heat up, and out through outlet openings (9) in the upper floor (8). The heat absorbed from the pipe loops (4) goes partly up through the upper floor (8), partly out into the room (2) as heated air. The pipe loops (4) extend transversely of the direction of movement of the air from the inlet (7) to the outlet (9) and are partly cast in concrete on the bottom of the chamber (16).

The present invention relates to a device for heating a room in a building at least in part by means of underfloor heating, the floor comprising a subfloor and an upper floor, between which there are pipe loops in which hot medium is circulated, further as stated in the preamble of claim 1.

Different designs of underfloor heating systems are known. In new construction, the pipe loops are usually cast into concrete, which tiles or other floor coverings are laid with a moisture barrier in between. When renovating or rehabilitating, where the building height must be limited, the pipe loops are usually laid in plastic knob plate or rigid insulation material on the existing floor. In all cases, the heat from the pipe loops must be conducted up through the floor covering, which can thereby have an uncomfortably high temperature during the winter and give a too cold feeling when the system is used for cooling in the summer.

A device as stated in the preamble of claim 1 is known from JP2009216323 A. Here, in the air spaces formed between the beams in the floor, loops of heating pipes are laid, running along the beams from one air space to another while emitting energy to the air flowing along them. This means that the last rooms will be significantly colder than the first, and that everyone will be disproportionately cold on the air intake side.

The invention aims i.a. to reduce these disadvantages and, at the same time, cause a quicker spread of the heat in the room. This is achieved according to the invention by a device as defined in the claims.

By causing the fresh air to be supplied to the room to pass the pipe loops in the chamber between the floors, it is heated, at the same time as it emits some of the heat to the upper floor, so that this has a comfortable temperature and contributes to a certain extent to the room heating. The rest of the heating is caused by the air flowing out of the outlet openings and quickly spreading in the room.

The invention is particularly suitable for use with energy systems of the type described in the applicant's European patent EP 2956723 B1. Here, the invention will make it possible to avoid radiators in the rooms and at the same time achieve a comfortable underfloor heating, as well as optimization of the heat pump that drives the energy system.

For a better understanding of the invention, it is described in the following in the form of the exemplary embodiments which are schematically shown in the accompanying drawings, in which

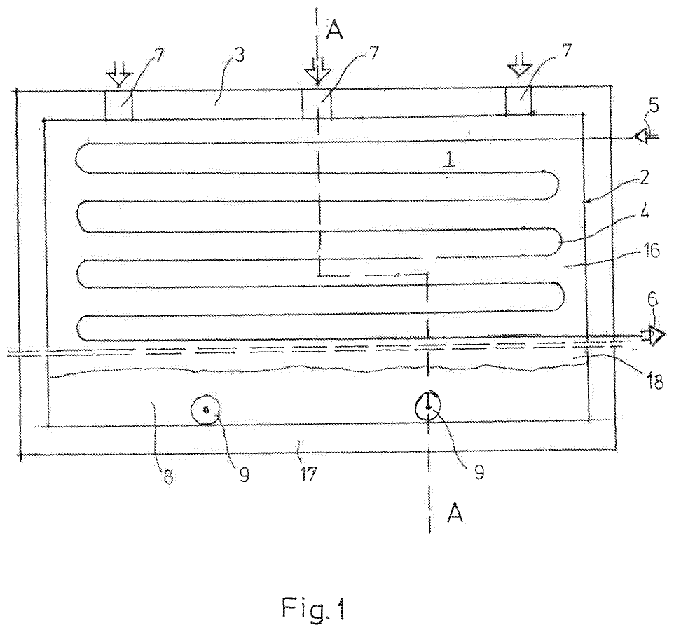

FIG. 1 is a greatly simplified plan view, almost to be regarded as a flow chart, of a device according to the invention,

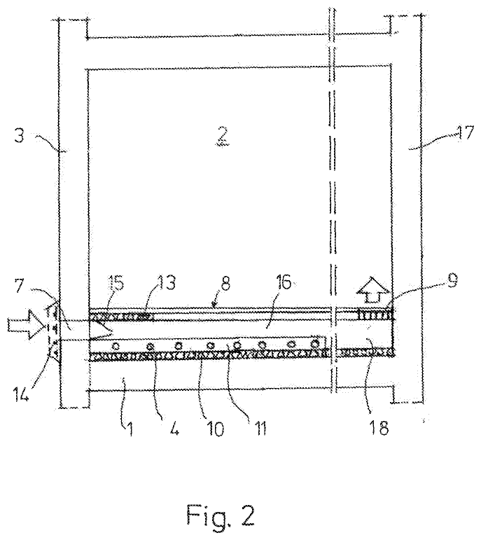

FIG. 2 is a section along the line A-A in FIG. 1,

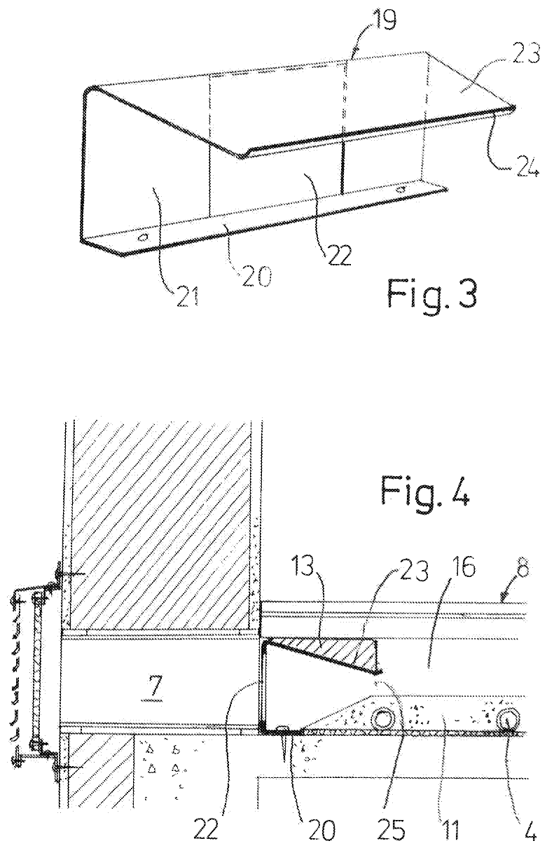

FIG. 3 is a perspective view of an air dispersing device for use in the invention, and

FIG. 4 is part of a section along the line A-A with the device of FIG. 3 installed.

FIG. 1 shows the subfloor 1 of a room 2 with an outer wall 3. On the subfloor there are pipe loops 4, which have an inlet indicated by the arrow 5 for hot supply water from a heat pump (not shown) and an outlet indicated by the arrow 6 for cooled return water. The inlet is closest to the outer wall 3 to provide the best possible heat dissipation in this area. In the outer wall 3, inlet openings 7 are arranged, through which cold outdoor air can be caused to flow in, preferably by creating a smaller negative pressure in the room 2, e.g. by means of an exhaust fan in the air pump's air outlet. Just inside the inlet openings, means can be arranged which accelerate and disperse the air over the pipe loops 4 for efficient heat absorption.

At a suitable distance above the subfloor 1, an upper floor 8 (partially shown) will be arranged in the room 2, which has outlet openings 9 for the heated air on the opposite side of the room 2 in relation to the inlet openings 7. Further details will appear from FIG. 2. Here, a layer of thermal insulation 10 is shown on the subfloor on which the pipe loops 4 rest, embedded in a layer of concrete 11 or the like. The upper floor 8 extends over the entire room 2 and is on its underside, in a portion closest to the inlet openings, 7 provided with thermal insulation 13. The upper floor 8 can be supported by longitudinal headers, for example (45×45 mm), c/c 600 mm, which in turn is supported by steel forks with a base plate resting on the subfloor 1. A continuous cavity in two dimensions is formed thereby, so that the incoming air can spread freely under the entire floor.

The inlet openings 7 are provided on the outside of the wall 3 with a replaceable filter 14, and on the inside, means 15 (omitted in FIG. 1) are arranged which restrict the air flow forward, at the same time as the air flow is spread laterally over the concrete layer 11 with the pipe loops 4. Between the floors 1, 8 an air-filled chamber 16991575649 is thus formed, in which heat from the concrete layer 11 spreads to the underside of the upper floor 8, primarily by convection, and further up through it.

The pipe loops 4 and the concrete layer 11 do not extend over the entire room 2, but are terminated at a certain distance from the wall 17 on the opposite side in relation to the outer wall 3. Thereby a portion 18 of the chamber 16 is formed which has a greater height than the rest. This portion 18 of the chamber 16 will then act as a diffuser, the air flowing out of the narrower portion of the chamber being slowed down and thereby recovering some of its original compressive energy. This promotes outflow to the room 2 through the outlet openings 9 in the upper floor 8. The width of the portion 18 can be about half of the total width of the room 2.

FIG. 3 shows an air spreading device in the form of a profiled section 19 made of sheet material, preferably galvanized steel. The profiled section has a base 20 for attachment to a subfloor, a back 21 with an air opening 22 and a sloping top piece 23 with an upwardly bent end edge 24. The profiled section 19 can be approximately 45 cm long and 10 cm high.

FIG. 4 is a vertical section through the air inlet portion 7 with the air spreading device 19 mounted. The base 20 is screwed to the subfloor 1 and is connected to an inclined end portion of the concrete layer 11. The opening 22 in the back 21 is aligned with the inlet opening 7, and the top piece 22 is covered at the top by insulating material 13. The inclined end portion of the concrete layer 11 and the top piece 22 become a kind of elongate, at both ends open funnel 25 forming a slit 26.

When fresh air from the inlet opening 7 flows in through the air opening 22, there will be a small stagnation pressure in the funnel 25. Some of the air will flow out through the slit 26, while most will be deflected and flow out laterally and spread along the outer wall 3 before flowing over the pipe loops 4 towards the outlet.

If the device according to the invention is for instance part of an energy system as mentioned above, the temperature of the return water 5 can be kept as low as 35-40° C. to give maximum efficiency of the heat pump.

1. A device for heating a room (2) in a building by means of underfloor heating, the floor comprising a subfloor (1) and an upper floor (8), between which pipe loops (4) are located in which a hot
where the inlet openings medium (5) can be circulated, where between the subfloor (1) and the upper floor (8) there is an air-filled chamber (16), the pipe loops being arranged in the chamber, and where the chamber (16) has inlet openings (7) for fresh air in a wall (3) at one of the room sides, and outlet openings (9) for air heated by the pipe loops (4) on another, preferably opposite, side of the room,
characterized in that the pipe loops (4) extend transversely of the direction of movement of the air from one side to the other of the room, that at least some of the pipe loops (4) are embedded in a thin layer of concrete (11) at the bottom of the chamber (16), and that the inlet openings (7) are connected to means (15) for dispersing the air to the chamber (16).

2. A device according to claim 1,
where the warmest part of the pipe loops (4) is close to said wall (3).

3. A device according to claim 1 or 2,
where the upper floor (8) is supported by spaced supports on the subfloor (1), whereby air mixing in the chamber (16) can take place unhindered.

4. A device according to one of the preceding claims,
where the upper floor (8) is provided with thermal insulation (13) on its underside in a portion closest to the inlet openings (7).

5. A device according to one of the preceding claims,
where the outlet openings (9) are located in the upper floor (8).

6. A device according to one of the preceding claims,
wherein thermal insulation (10) is located at the bottom of the chamber (16).

7. A device according to one of the preceding claims,
(7) are provided with a replaceable filter (14), preferably on the outside of the wall (3).

8. A device according to one of the preceding claims,
wherein the chamber (16) has a greater free height in a portion (18) closest to the outlet openings (9), which portion preferably forms approximately half of the chamber (16) and is without pipe loops (4).

9. A device according to one of the preceding claims,
wherein the medium (5) which can be circulated in the pipe loops (4), preferably water, can have a temperature of 35-40° C. at the inlet of the pipe loops (4) which are located near the air inlets (7).

10. A device according to one of the preceding claims,
where the medium (5) which can be circulated in the pipe loops (4) is heated by a heat pump.
